(19) United States
(12) Patent Application Publication
(10) Pub. No.: US 2005/0225162 A1
(43) Pub. Date: Oct. 13, 2005

(54) Compaction wheel and cleat assembly therefor

(76) Inventor: John Gibbins, Elanora (AU)

Correspondence Address: DAVID A. GUERRA, 933 OLANDER WAY SOUTH, SUITE 3, SOUTH PASADENA, FL, 33707, US

(21) Appl. No.: 10/506,351

(22) PCT Filed: Mar. 19, 2003
(86) PCT No.: PCT/AU03/00330

§ 371 Date: Sep. 2, 2004

(30) Foreign Application Priority Data
Mar. 20, 2002 (AU) PS 1243

(51) Int. Cl. B60B 15/02

(52) U.S. Cl. 301/43

(57) ABSTRACT

A compaction wheel (20) for landfill compactors is disclosed. The compaction wheel (20) includes a rim (21) and a plurality of cleats (50, 80) secured thereto with a plurality of spring clips (51). The rim (21) includes an exterior surface (30), an interior surface (31), and a plurality of cleat-receiving apertures (33) extending therethrough between the exterior and interior surfaces (30, 31). Each of the cleats (50, 80) includes a ground-engaging portion (52), a lug portion (53) extending from the ground-engaging portion (52), and a clip-receiving aperture (54, 55) extending through the lug portion (53). Each of the cleats (50, 80) being mountable on the rim (21) such that the ground-engaging portions (52) project from the exterior surface (30) of the rim (21) while the lug portions (53) extend through the cleat-receiving apertures (33) of the rim (21) so that the clip-receiving apertures (54, 55) are situated adjacent the interior surface (31) of the rim (21) and lateral movement of the cleats (50, 80) relative to the rim (21) is inhibited. The spring clips (51) being adapted to secure the mounted cleats (50, 80) to the rim (21) by engaging with the clip-receiving apertures (54, 55) and interacting with the rim and cleats such that the ground-engaging portions (52) of the cleats (50, 80) are pulled towards the rim (21).

### FIELD OF THE INVENTION

The present invention generally relates to compaction wheels. In particular, the invention relates to compaction wheels of the type which include a rim and a plurality of cleats secured thereto.

The invention will be described by way of example with reference to compaction wheels for landfill and soil compactors. However, it should be appreciated that this is by way of example only and that the invention may be used in conjunction with other types of compaction wheels.

### DESCRIPTION OF THE PRIOR ART

Machines such as landfill and soil compactors are usually fitted with compaction wheels instead of crawler tracks or wheel and tyre assemblies. The compaction wheels are specifically designed to crush or compact material such as waste, soil and the like which they pass over.

Compaction wheels of the aforementioned type generally include a cylindrical metal rim having a plurality of metal cleats secured thereto such that the cleats are circumferentially spaced around the rim and project from an exterior surface thereof. The cleats function to improve the traction and compacting characteristics of the compaction wheels.

In the past, compaction wheels have typically been constructed using one-piece cleats which are welded, bolted or pinned to the rim. Also, in the case of two-piece cleats which include a base and a harder, more wear-resistant cap, the base has been welded, bolted or pinned to the rim while the cap has been welded, bolted, or pinned to the base.

With use, the cleats of a compaction wheel become worn and need to be replaced. Prior cleat designs suffer from several drawbacks in this respect. For example, with the prior designs it is often necessary to firstly remove foreign material such as mud or garbage from the exterior of the wheel to permit removal of the welds, pins or bolts which secure the cleats to the wheel rim. This is dirty and highly undesirable work. Moreover, in two-piece designs, the pins or bolts are situated such that they are often exposed to corrosive materials that can make them difficult to remove. Additionally, field replacement of the prior art cleats typically requires that service vehicles carry expensive equipment such as air compressors, air hammers, sledge hammers, torches and welding machines.

U.S. Pat. No. 6,095,717 (Kaldenberg et al.) discloses a compaction wheel that overcomes many of the aforementioned deficiencies. The compaction wheel which is disclosed by the patent has an outer rim including a plurality of cleat-receiving apertures extending therethrough and a plurality of replaceable cleats mounted thereon. A plurality of annular rings are mounted inside the rim such that each cleat-receiving aperture has a pair of these rings situated adjacent opposite sides thereof. Each cleat includes a ground-engaging portion and a lug portion extending from the ground-engaging portion. The cleats are mounted on the outer rim by inserting the lug portions thereof into a respective cleat-receiving aperture. Each cleat is then secured to the outer rim by inserting a rod through an associated aperture which extends through the lug and the annular rings which are adjacent the lug.

In use, compaction wheels according to the Kaldenberg et al. patent have been found to perform less than satisfactorily, as the cleats and rods thereof tend to loosen with use so that the cleats are able to move relative to and rub against the outer rim causing the outer rim to wear prematurely.

It is an object of the present invention to provide a compaction wheel or cleat assembly which substantially overcomes, or at least ameliorates, one or more of the deficiencies associated with the prior art, or which provides the consumer with a useful or commercial choice.

Other objects and advantages of the present invention will become apparent from the following description, taken in connection with the accompanying drawings, wherein, by way of illustration and example, various embodiments of the present invention are disclosed.

### SUMMARY OF THE INVENTION

According to a first aspect of the present invention there is provided a compaction wheel for landfill compactors, the compaction wheel including a rim and a plurality of cleats secured thereto with a plurality of spring clips, the rim including an exterior surface, an interior surface, and a plurality of cleat-receiving apertures extending therethrough between the exterior and interior surfaces, each of the cleats including a ground-engaging portion, a lug portion extending from the ground-engaging portion, and a clip-receiving aperture extending through the lug portion, each of the cleats being mountable on the rim such that the ground-engaging portions project from the exterior surface of the rim while the lug portions extend through the cleat-receiving apertures of the rim so that the clip-receiving apertures are situated adjacent the interior surface of the rim and lateral movement of the cleats relative to the rim is inhibited, the spring clips being adapted to secure the mounted cleats to the rim by engaging with the clip-receiving apertures and interacting with the rim and cleats such that the ground-engaging portions of the cleats are pulled towards the rim.

Preferably, the spring clips contact the interior surface of the rim.

The compaction wheel may include a plurality of sleeves each lining a respective cleat-receiving aperture. Also, each sleeve may include a flange portion abutting against the interior surface of the rim and a portion of a respective spring clip such that the spring clips force the sleeves and ground-engaging portions of the cleats towards each other. The sleeves may also be tack-welded to the rim.

The clip-receiving apertures may include chamfered or rounded edges defining the openings thereof.

In a preferred form, the lug portion of each cleat has a single clip-receiving aperture extending therethrough. Alternatively, the lug portion of each cleat may have a plurality of clip-receiving apertures extending therethrough.

Preferably, the spring clips are generally U-shaped and include a pair of arms which extend through respective clip-receiving apertures of the cleats. The spring clips may be adapted to extend through only a single clip-receiving aperture of the cleats.

The cleats may be mounted on the rim such that they extend in a plurality of substantially straight lines on the exterior surface of the rim. Alternatively, the cleats may be mounted on the rim such that they form a plurality of chevron or helix patterns on the exterior surface of the rim.

According to a second aspect of the present invention there is provided a cleat assembly for compaction wheels of the type which are used on landfill compactors and which include a rim including an exterior surface, an interior surface, and a cleat-receiving aperture extending therethrough between the exterior and interior surfaces, the cleat assembly including a cleat and a spring clip for securing the cleat to the rim, the cleat including a ground-engaging portion, a lug portion extending from the ground-engaging portion, and a clip-receiving aperture extending through the lug portion, the cleat being mountable on the rim such that the ground-engaging portion projects from the exterior surface of the rim while the lug portion extends through the cleat-receiving aperture of the rim so that the clip-receiving aperture is situated adjacent the interior surface of the rim and lateral movement of the cleat relative to the rim is inhibited, the spring clip being adapted to secure the mounted cleat to the rim by engaging with the clip-receiving aperture and interacting with the rim and the cleat such that the ground-engaging portion of the cleat is pulled towards the rim.

The cleat assembly may include a sleeve for lining the cleat-receiving aperture. The sleeve may include a flange portion for abutting against the interior surface of the rim and a portion of the spring clip such that the spring clip forces the sleeve and ground-engaging portion of the cleat towards each other.

The clip-receiving aperture may include chamfered or rounded edges defining the openings thereof.

In a preferred form, the lug portion of the cleat has a single clip-receiving aperture extending therethrough. Alternatively, the lug portion of the cleat may have a plurality of clip-receiving apertures extending therethrough.

Preferably, the spring clip is generally U-shaped and includes a pair of arms which are adapted to extend through respective clip-receiving apertures of the cleat. The spring clip may be adapted to extend through only a single clip-receiving aperture of the cleat.

### BRIEF DESCRIPTION OF THE DRAWINGS

In order that the invention may be more fully understood and put into practice, various embodiments thereof will now be described with reference to the accompanying drawings, in which:

FIG. 1 is a partial sectional end elevation of a first portion of a compaction wheel according to a preferred embodiment of the present invention which includes a first type of cleat mounted on a rim;

FIG. 2 is a partial sectional side elevation of the portion of the compaction wheel illustrated in FIG. 1 which includes a spring clip securing the cleat to the rim;

FIG. 3 is a partial sectional end elevation of a second portion of the preferred embodiment of the compaction wheel which includes a second type of cleat mounted on the rim;

FIG. 4 is a partial sectional side elevation of the portion of the compaction wheel illustrated in FIG. 3 which includes a spring clip securing the cleat to the rim;

FIG. 5 is an interior view of a portion of the preferred embodiment of the compaction wheel which illustrates the lug portion of a cleat in a mounted condition on the rim prior to the cleat being secured to the rim with a spring clip;

FIG. 6 is an interior view of the same portion of the compaction wheel illustrated in FIG. 5 which illustrates the lug portion of the mounted cleat after the cleat has been secured to the rim with the spring clip;

FIG. 7 is a perspective view of the rim of the preferred embodiment of the compaction wheel;

FIG. 8 is a sectional side elevation of the rim illustrated in FIG. 7 taken along the line 8-8;

FIG. 9 is a perspective view of the preferred embodiment of the compaction wheel including the rim with a plurality of cleats mounted thereon;

FIG. 10 is a partial sectional end elevation of a portion of a compaction wheel according to an alternative embodiment of the present invention which includes a sleeve lining a cleat-receiving aperture of the rim;

FIG. 11 is a partial sectional side elevation of the portion of the compaction wheel illustrated in FIG. 10 which includes a spring clip securing the cleat and sleeve to the rim; and

FIG. 12 is a perspective view of an alternative spring clip which may be used to secure a cleat to a rim in a manner which embodies the present invention.

### DETAILED DESCRIPTION

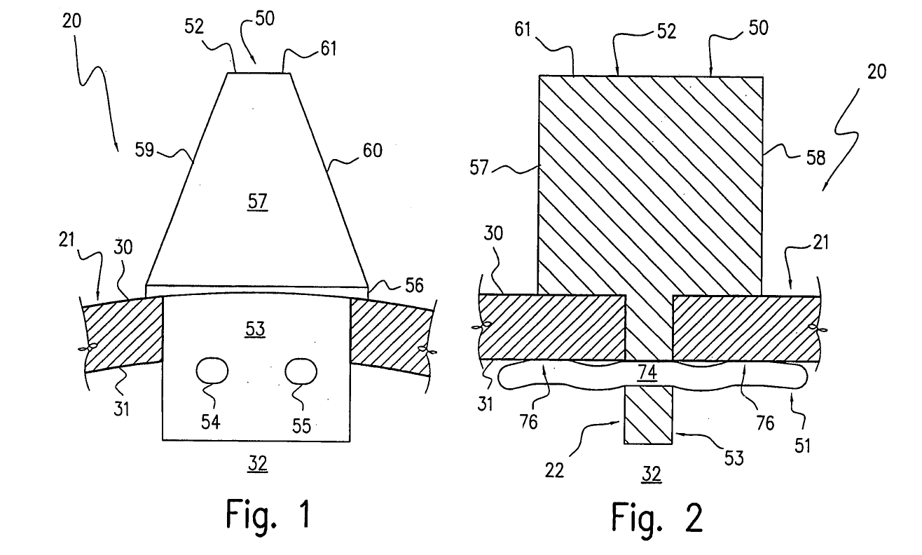

FIGS. 1 and 2 illustrate a portion of a preferred embodiment of a compaction wheel 20 according to the present invention which may be employed with a landfill compactor. The compaction wheel 20 includes a rim 21 and a plurality of cleat assemblies 22 (note that only one complete cleat assembly 22 is illustrated in FIG. 2) secured thereto.

Rim 21 is constructed from a suitable material such as steel and is in the form of a hollow cylinder. The rim 21 includes an exterior surface 30, an interior surface 31, and an interior region 32 which is bordered by the interior surface 31.

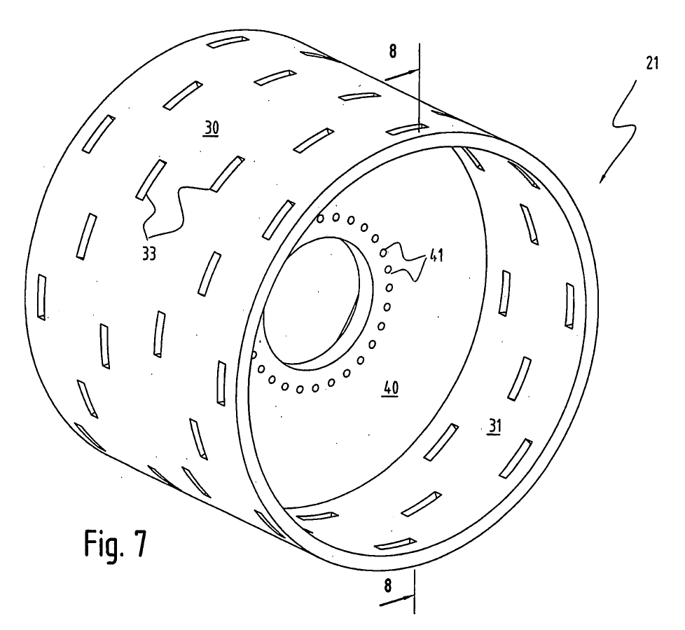

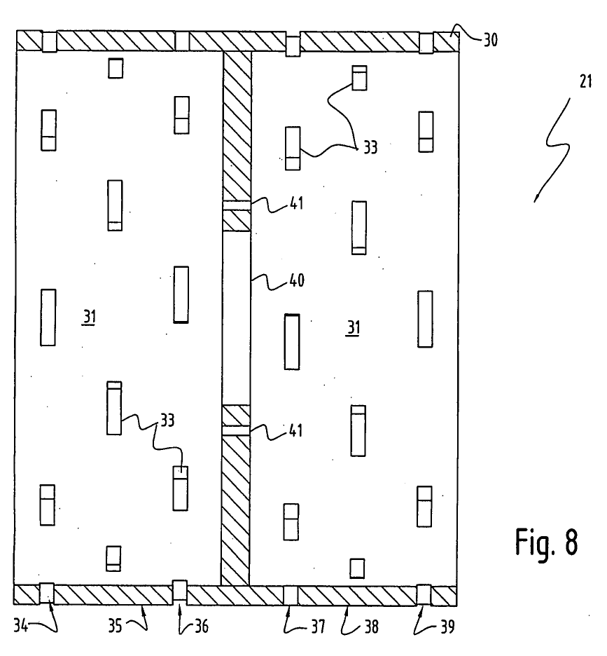

Referring to FIGS. 7 and 8, a plurality of rectangular cleat-receiving apertures 33 extend through the rim 21 between the exterior and interior surfaces 30, 31 thereof. The cleat-receiving apertures 33 are arranged into a plurality of bands 34 to 39 (see FIG. 8) which extend around the circumference of the rim 21 such that each band 34 to 39 includes a plurality of circumferentially spaced cleat-receiving apertures 33. Each cleat-receiving aperture 33 includes two orthogonal pairs of opposing sidewalls with the sidewalls of each pair being parallel to each other. The cleat-receiving apertures 33 are normally only formed in the rim 21 after the rim 21 has been formed into its basic cylindrical shape so as to prevent the apertures 33 from being distorted during the shaping process as would happen if they were otherwise formed prior to this stage of manufacture.

A mounting disc 40 is located in the interior region 32 of the rim 21 and is transversely arranged with respect to the longitudinal axis of the rim 21. The disc 40 is attached to the rim 21 by welding or other appropriate means such that the interior region 32 of the rim 21 is partitioned into two distinct regions. The mounting disc 40 is adapted to enable the wheel 20 to be secured to an axle of a landfill compactor. In particular, the mounting disc 40 includes a plurality of lug-receiving apertures 41 that are each adapted to receive an associated threaded lug which extends from an end of the axle of the landfill compactor so that the mounting disc 40 and, hence, the compaction wheel 20 can be securely bolted to the axle. The mounting disc also includes a large central aperture which is surrounded by the lug-receiving apertures 41 and which receives a hub of the axle.

Referring to FIGS. 1 and 2 again, the illustrated cleat assembly 22 includes a first type of cleat 50 and a spring clip 51 for securing the cleat 50 to the rim 21. Both the cleat 50 and the spring clip 51 are constructed from any suitable material such as steel.

Cleat 50 includes a ground-engaging portion 52, a lug portion 53 extending from the ground-engaging portion 52, and a pair of clip-receiving apertures 54, 55 extending transversely through the lug portion 53. Cleat 50 is mountable on the rim 21 such that the ground-engaging portion 52 projects from the exterior surface 30 of the rim 21 while the lug portion 53 extends through the cleat-receiving aperture 33 of the rim 21 so that the clip-receiving apertures 54, 55 are situated adjacent the interior surface 31 of the rim 21 and lateral movement of the cleat 50 relative to the rim 21 is inhibited.

The ground-engaging portion 52 includes a base portion 56 which is generally in the form of a rectangular prism having a curved underside which is adapted to rest against the curved exterior surface 30 of the rim 21. The ground-engaging portion 52 also has a pair of opposed flat trapezium-shaped sides 57, 58, a pair of opposed flat rectangular-shaped sides 59, 60 extending between the trapezium-shaped sides 57, 58, and a flat rectangular-shaped upper side 61. The cleat 50 is designed so that the trapezium-shaped sides 57, 58 thereof extend transversely with respect to the longitudinal axis of the rim 21 when the cleat 50 is mounted on the rim 21.

The lug portion 53 is substantially in the form of a rectangular prism and has dimensions which inhibit lateral movement of the lug portion 53 within the aperture 33 when the cleat 50 is mounted on the rim 21, but which allow the lug portion 53 to be readily inserted into and removed from the cleat-receiving aperture 33 when the cleat 50 is not secured to the rim 21.

Each of the clip-receiving apertures 54, 55 are slightly elongated and are oriented such that they are parallel with respect to each other and the longitudinal axis of the rim 21 when the cleat 50 is mounted thereon in the previously described manner.

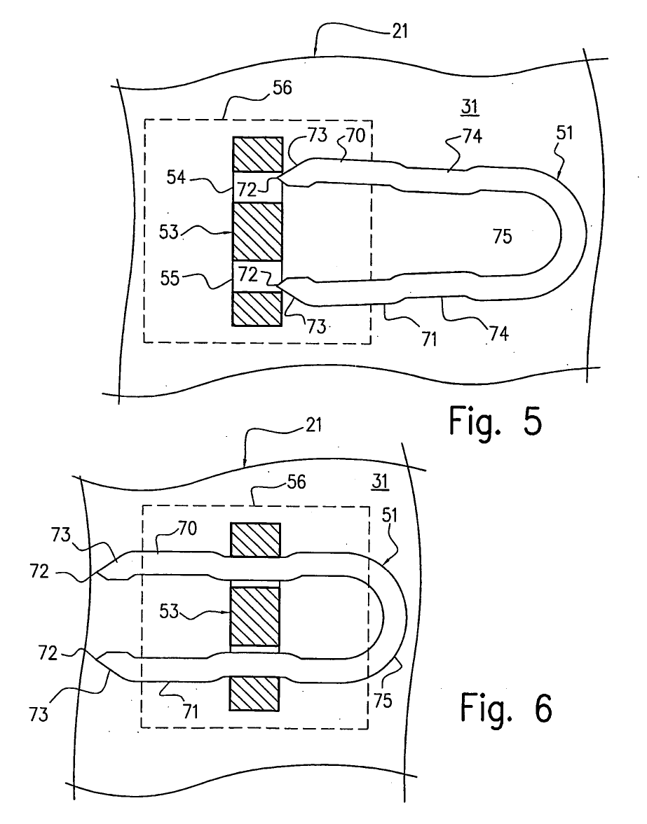

Referring to FIGS. 5 and 6, the spring clip 51 is a resilient and generally U-shaped clip which has a pair of arms 70, 71 that are each adapted to extend through a respective clip-receiving aperture 54, 55 of the cleat 50. Each arm 70, 71 has a pointed tip 72 and a tapered portion 73 which assists in guiding the arms 70, 71 into their respective clip-receiving apertures 54, 55. Each arm 70, 71 also has an indented portion 74 which is slightly longer than the length of the clip-receiving apertures 54, 55. The clip 51 is adapted to secure the mounted cleat 50 to the rim 21 such that each arm 70, 71 of the clip 51 extends through a respective clip-receiving aperture 54, 55 and such that the indented portions 74 of the arms 70, 71 are substantially located within their respective clip-receiving apertures 54, 55. In particular, the spring clip 51 is adapted so that when the arms 70, 71 extend through their respective clip-receiving apertures 54, 55 in the manner just described, each arm 70, 71 pushes against the interior surface of their respective clip-receiving aperture 54, 55 such that the arms 70, 71 push in opposite directions to each other. This pushing together with the presence of the indented portions 74 of the arms 70, 71 assists in preventing the spring clip 51 from working itself loose from the clip-receiving apertures 54, 55 and allowing the cleat 50 to fall off the rim 21.

To secure the mounted cleat 50 to the rim 21, the spring clip 51 is firstly positioned relative to the cleat 50 in the manner illustrated in FIG. 5. The arms 70, 71 are then inserted into the apertures 54, 55 by striking a bridging portion 75 of the spring clip 51 towards the lug portion 53 of the cleat 50 using a hammer or other suitable tool until the indented portions 74 coincide with the clip-receiving apertures 54, 55 as illustrated in FIG. 6.

Referring to FIG. 2, the spring clip 51 is adapted to secure the cleat 50 to the rim 21 by engaging with the clip-receiving apertures 54, 55 and interacting with the rim 21 and the cleat 50 such that the ground-engaging portion 52 of the cleat 50 is pulled towards the rim 21. In particular, the configuration of the spring clip 51 is such that rim-contacting portions 76 thereof contact the interior surface 31 of the rim 21, and the indented portions 74 of the arms 70, 71 pull against the cleat 50 such that the ground-engaging portion 52 thereof is pulled towards the rim 21.

While the spring clip 51 can be removed by simply reversing the above-described insertion procedure, it is usually easier to simply cut the bridging portion 75 of the spring clip 51 with an oxyacetylene torch or other suitable apparatus and to then remove the individual arms 70, 71 from the apertures 54, 55 of the cleat 50. Removal of the arms 70, 71 then allows the cleat 50 to be dismounted from the rim 21.

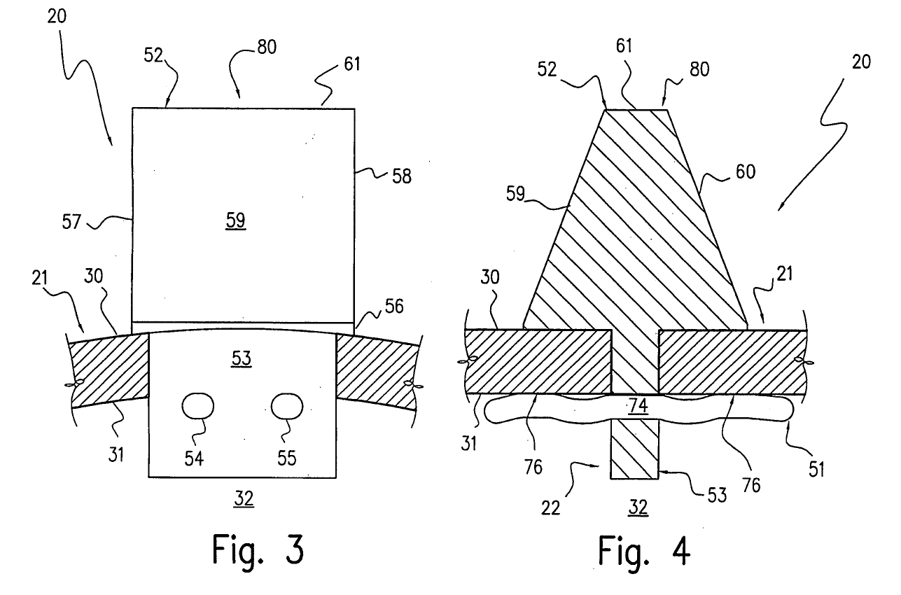

Referring to FIGS. 3 and 4, a second type of cleat 80 is illustrated mounted on the rim 21. For convenience, features of the cleat 80 that are similar or correspond to features of the cleat 50 have been referenced using the same reference numbers.

Cleat 80 differs from cleat 50 in that the ground-engaging portion 52 of cleat 80 has been modified. In particular, the trapezium-shaped sides 57, 58 of the ground-engaging portion 52 are parallel with respect to the longitudinal axis of the rim 21 when the cleat 80 is mounted on the rim 80.

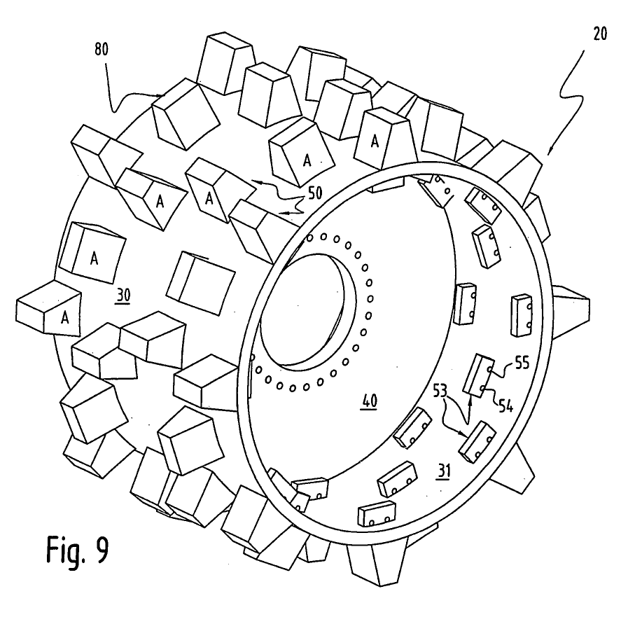

FIG. 9 illustrates the compaction wheel 20 which includes a plurality of the cleats 50, 80 mounted on the rim 21. For clarity, the spring clips 51 which secure the cleats 50, 80 to the rim 21 have not been shown. From FIG. 9, the different orientation of the ground-engaging portions 52 of the cleats 50, 80 is apparent, as is the identical orientation of the lug portions 53 of the cleats 50, 80 relative to the rim 21 so that the clip-receiving apertures 54, 55 of the cleats 50, 80 are parallel with respect to the longitudinal axis of the rim 21.

The cleats 50, 80 are mounted on the rim 21 such that they form a plurality of helical patterns the exterior surface 30 of the rim 21. The cleats 50, 80 of one such pattern have been referenced using the letter “A”.

The compaction wheel 20 and cleat assembly 22 which embody the present invention provide a significant advantage over the prior art in that the design of the cleats 50, 80 combined with the way in which they are secured to the rim 21 with the spring clips 51 inhibits the cleats 50, 80 from becoming loose and damaging the rim 21.

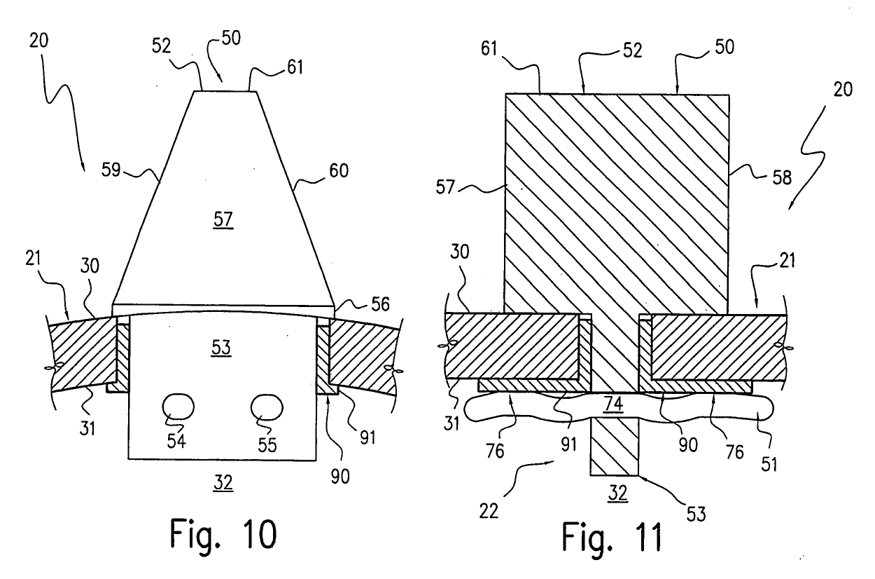

The foregoing describes only one embodiment of the present invention and modifications, obvious to those skilled in the art, can be made thereto without departing from the scope of the present invention. For example, referring to FIG. 10, the cleat assembly 22 may include a cast or forged steel sleeve 90 which lines the sidewalls of the cleat-receiving aperture 33 to further protect against undesirable rubbing between the cleat 50 and the rim 21 in the event that there is some play between the lug portion 53 of the cleat 50 and the aperture 33. Such rubbing is undesirable as it can result in premature wearing of the rim 21 which is often constructed from unhardened steel as opposed to the hardened steel from which the cleats are often constructed. The sleeve 90 may include a flange portion 91 which abuts against the interior surface 31 of the rim 21 to prevent the sleeve 90 from falling out of the aperture 33 when the cleat 50 and sleeve 90 are not secured to the rim 21 with the spring clip 51. The length of the sleeve 90 is such that there is a small gap between the sleeve 90 and the ground-engaging portion 52 of the cleat 50 when the sleeve 90 is inserted into the cleat-receiving aperture 33. In addition to abutting against the interior surface 31 of the rim 21, the flange portion 91 abuts against portions 76 of the spring clip 51 such that the spring clip 51 forces the sleeve 90 and ground-engaging portion 52 of the cleat 50 towards each other. A sleeve 90 which does or does not have the flange portion 91 may also be tack-welded to the rim 11 to prevent the sleeve 90 from falling off the rim 21. The tack-welds should be such that they can be readily cut or otherwise broken so that the sleeve 90 can be removed from the aperture 33.

Also, the edges which define the openings of the clip-receiving apertures 54, 55 may be chamfered, rounded, or otherwise adapted to prevent them from inadvertently damaging the spring 51 when the spring 51 is inserted into the apertures 54, 55. It is advantageous to do this as damaged springs 51 are susceptible to fail.

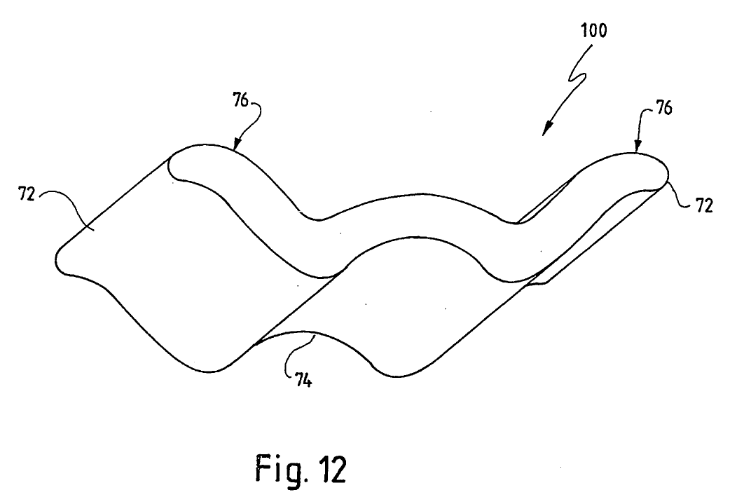

A further modification which can be made to the cleats 50, 80 described above is that they may have any number of clip-receiving apertures 54, 55 extending through their respective lug portions 53. For example, a single clip-receiving aperture or more than two such apertures may extend through the lug portions 53 of the cleats 50, 80. If a single clip-receiving aperture extends through the lug portion 53 of a cleat 50 or 80, then a spring clip such as the spring clip 100 illustrated in FIG. 12 may be used to secure the cleat to the rim 21. The spring clip 100 is essentially a broadened and flattened version of one of the arms 70, 71 of the spring clip 51 which was described above in connection with the preferred embodiment of the invention. Therefore, for convenience, features of the spring clip 100 that are similar or correspond to features of the spring clip 51 have been referenced using the same reference numbers. Apart from being broader and flatter than the arms 70, 71 of the spring clip 51, the indented portion 74 of the spring clip 100 is curved rather than linear. The curved indented portion 74 is able to be received within a similarly curved clip-receiving aperture. The spring clip 100 does not have any sharp edges so as to avoid damaging the cleat. The additional breadth of the spring clip 100 serves to prevent the clip 100 from rotating within the suitably dimensioned clip-receiving aperture of the cleat which receives the clip 100. Also, once the clip 100 has secured the cleat to the rim 21, the clip 100 has a profile which is essentially the same as the profile of the clip 51 as illustrated in FIG. 2.

It will be appreciated that many other types of spring clips which are neither described nor contemplated here may be used to secure the cleats 50 or 80 to the rim 21, and that the springs clips 51, 100 which have been described here have been given by way of example only.

It should also be appreciated that the mounted cleats 50, 80 may be arranged on the rim 21 in a different manner to that described above in connection with the description of the preferred embodiment. For example, the cleats 50, 80 may be arranged into lines which extend across the exterior surface 30 of the rim 21 and which are parallel with the longitudinal axis of the rim 21. Alternatively, the cleats 50, 80 may be arranged to form chevron patterns on the exterior surface 30 of the rim 11.

1. A compaction wheel for landfill compactors, the compaction wheel including a rim and a plurality of cleats secured thereto with a plurality of spring clips, the rim including an exterior surface, an interior surface, and a plurality of cleat-receiving apertures extending therethrough between the exterior and interior surfaces, each of the cleats including a ground-engaging portion, a lug portion extending from the ground-engaging portion, and a clip-receiving aperture extending through the lug portion, each of the cleats being mountable on the rim such that the ground-engaging portions project from the exterior surface of the rim while the lug portions extend through the cleat-receiving apertures of the rim so that the clip-receiving apertures are situated adjacent the interior surface of the rim and lateral movement of the cleats relative to the rim is inhibited, the spring clips being adapted to secure the mounted cleats to the rim by engaging with the clip-receiving apertures and interacting with the rim and cleats such that the ground-engaging portions of the cleats are pulled towards the rim.

2. The compaction wheel of claim 1, wherein the spring clips contact the interior surface of the rim.

3. The compaction wheel of claim 1 further including a plurality of sleeves each lining a respective cleat-receiving aperture.

4. The compaction wheel of claim 3, wherein each sleeve includes a flange portion abutting against the interior surface of the rim and a portion of a respective spring clip such that the spring clips force the sleeves and ground-engaging portions of the cleats towards each other.

5. The compaction wheel of claim 3 or 4, wherein the sleeves are tack-welded to the rim.

6. The compaction wheel of claim 1, wherein the clip-receiving apertures include chamfered edges defining the openings thereof.

7. The compaction wheel of claim 1, wherein the clip-receiving apertures include rounded edges defining the openings thereof.

8. The compaction wheel of claim 1, wherein the lug portion of each cleat has a single clip-receiving aperture extending therethrough.

9. The compaction wheel of claim 1, wherein the lug portion of each cleat has a plurality of clip-receiving apertures extending therethrough.

10. The compaction wheel of claim 1, wherein the spring clips are generally U-shaped and include a pair of arms which extend through respective clip-receiving apertures of the cleats.

11. The compaction wheel of claim 1, wherein the spring clips are adapted to extend through only a single clip-receiving aperture of the cleats.

12. The compaction wheel of claim 1, wherein the cleats are mounted on the rim such that they extend in a plurality of substantially straight lines on the exterior surface of the rim.

13. The compaction wheel of claim 1, wherein the cleats are mounted on the rim such that they form a plurality of chevron patterns on the exterior surface of the rim.

14. The compaction wheel of claim 1, wherein the cleats are mounted on the rim such that they form a plurality of helix patterns on the exterior surface of the rim.

15. A cleat assembly for compaction wheels of the type which are used on landfill compactors and which include a rim including an exterior surface, an interior surface, and a cleat-receiving aperture extending therethrough between the exterior and interior surfaces, the cleat assembly including a cleat and a spring clip for securing the cleat to the rim, the cleat including a ground-engaging portion, a lug portion extending from the ground-engaging portion, and a clip-receiving aperture extending through the lug portion, the cleat being mountable on the rim such that the ground-engaging portion projects from the exterior surface of the rim while the lug portion extends through the cleat-receiving aperture of the rim so that the clip-receiving aperture is situated adjacent the interior surface of the rim and lateral movement of the cleat relative to the rim is inhibited, the spring clip being adapted to secure the mounted cleat to the rim by engaging with the clip-receiving aperture and interacting with the rim and the cleat such that the ground-engaging portion of the cleat is pulled towards the rim.

16. The cleat assembly of claim 15 further including a sleeve for lining the cleat-receiving aperture.

17. The cleat assembly of claim 16, wherein the sleeve includes a flange portion for abutting against the interior surface of the rim and a portion of the spring clip such that the spring clip forces the sleeve and ground-engaging portion of the cleat towards each other.

18. The cleat assembly of claim 15, wherein the clip-receiving aperture includes chamfered edges defining the openings thereof.

19. The cleat assembly of claim 15, wherein the clip-receiving aperture includes rounded edges defining the openings thereof.

20. The cleat assembly of claim 15, wherein the lug portion of the cleat has a single clip-receiving aperture extending therethrough.

21. The cleat assembly of claim 15, wherein the lug portion of the cleat has a plurality of clip-receiving apertures extending therethrough.

22. The cleat assembly of claim 15, wherein the spring clip is generally U-shaped and includes a pair of arms which are adapted to extend through respective clip-receiving apertures of the cleat.

23. The cleat assembly of claim 15, wherein the spring clip is adapted to extend through only a single clip-receiving aperture of the cleats.
